(19) United States
(12) Patent Application Publication
(10) Pub. No.: US 2011/0216238 A1
(43) Pub. Date: Sep. 8, 2011

(54) OPTICAL ELEMENT, OPTICAL ELEMENT MANUFACTURING METHOD, AND CAMERA MODULE

(76) Inventors: Mika FUJII, Kanagawa (JP); Mie Matsuo, Kanagawa (JP)

(21) Appl. No.: 13/039,107

(22) Filed: Mar. 2, 2011

(30) Foreign Application Priority Data
Mar. 3, 2010 (JP) 2010-047028

(51) Int. Cl. G02B 1/10; H04N 5/225; G02B 7/02; B05D 5/06; G02B 1/12

(52) U.S. Cl. 348/374; 359/811; 359/601; 427/162; 216/26; 348/E05.025

(57) ABSTRACT

According to one embodiment, an optical element includes: a substrate in which a through-hole is formed; a transparent thin film formed on at least one of the rear surface and the front surface of the substrate to cover the through-hole; and a lens formed in contact with the surface of the thin film in an area where the thin film covers the through-hole.

### CROSS-REFERENCE TO RELATED APPLICATIONS

This application is based upon and claims the benefit of priority from the prior Japanese Patent Application No. 2010-047028, filed on Mar. 3, 2010; the entire contents of which are incorporated herein by reference.

### FIELD

Embodiments described herein relate generally to an optical element, an optical element manufacturing method, and a camera module.

### BACKGROUND

As an imaging lens mounted on a cellular phone or the like, a plastic lens is used for a reduction in cost. Further, for a reduction in cost, a technology for forming a large number of plastic lenses on a substrate and generating, as an imaging lens, an optical element singulated by cutting the plastic lenses together with the substrate is used.

As a method of forming a large number of plastic lenses on a substrate, for example, Japanese Patent Application Laid-Open No. 07-174902 discloses the structure of a micro lens and a method of manufacturing the micro lens for forming a light shielding layer on a surface at least on one side of a substrate, which is a transparent parallel flat plate, and forming, on the light shielding layer, a hardening resin section having a refracting surface array matching an array of lens openings.

In the method of forming plastic lenses on a substrate disclosed in Japanese Patent Application Laid-Open No. 07-174902, it is necessary to use a transparent substrate as the substrate. On the other hand, in the case of bulk products, because components incorporating imaging lenses are mounted on a substrate by a reflow process, it is necessary to secure heat resistance of the imaging lenses. Therefore, a heat resistant socket is used or, for example, a method of forming plastic lenses on a transparent heat resistant substrate is used. However, manufacturing cost is high in these methods.

When a glass substrate is used as the transparent substrate, the thickness of a substrate for maintaining strength occupies most of the thickness of an optical element (a plastic lens and the substrate) and obstructs improvement of optical performance.

In Japanese Patent Application Laid-Open No. 07-181304, a micro lens having structure in which a lens section is a hole as means for using a non-transparent substrate and a method of manufacturing the micro lens are devised. In this manufacturing method, lenses are formed by dropping hardening resin into a plurality of through-holes of a substrate and hardening the hardening resin. A uniform lens shape is obtained by surface tension.

However, in the technology disclosed in Japanese Patent Application Laid-Open No. 07-181304, a lens shape is limited because the lens shape is formed by making use of the surface tension of a material. Conversely, to freely form a lens shape using the method of Japanese Patent Application Laid-Open No. 07-181304, it is necessary to press dies against a lens from both the top and the bottom of the lens. Therefore, it is difficult to inexpensively manufacture an aspherical lens and the like.

### BRIEF DESCRIPTION OF THE DRAWINGS

FIGS. 1A to 1C are diagrams of an example of the structure of an optical element according to a first embodiment;

FIG. 2 is a diagram of an example of the structure of an optical element according to a second embodiment;

FIGS. 3A and 3B are diagrams of examples of other kinds of the structure of the optical element according to the second embodiment;

FIGS. 4A to 4G are diagrams of an example of steps of a method of manufacturing an optical element according to a third embodiment; and

FIG. 5 is a sectional view of an example of the structure of a camera module according to a fourth embodiment.

### DETAILED DESCRIPTION

In general, according to one embodiment, an optical element includes: a substrate in which a through-hole is formed; a transparent thin film formed on at least one of the rear surface and the front surface of the substrate to cover the through-hole; and a lens formed in contact with the surface of the thin film in an area where the thin film covers the through-hole.

Exemplary embodiments of an optical element and a camera module will be explained below in detail with reference to the accompanying drawings. The present invention is not limited to the following embodiments.

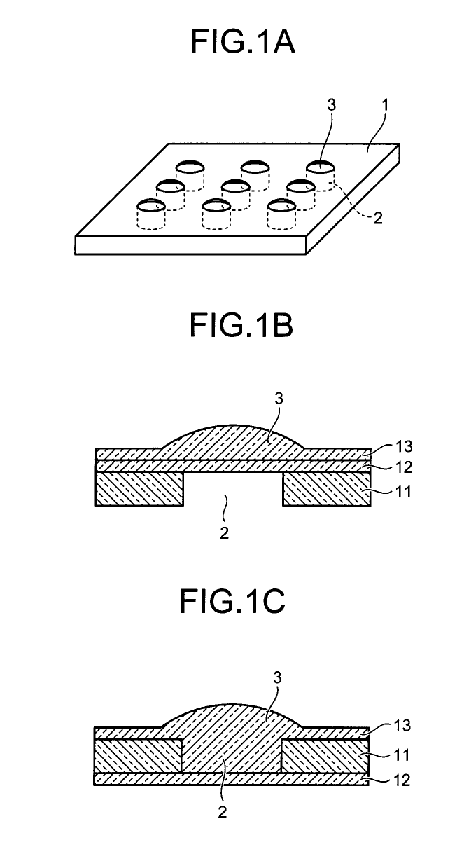

FIGS. 1A to 1C are diagrams of an example of the structure of optical elements according to a first embodiment. An overview of a lens sheet before singulation of the optical elements is shown in FIG. 1A. An example of a sectional view of the lens sheet corresponding to one optical element is shown in FIG. 1B. Another example of the sectional view of the lens sheet corresponding to one optical element different from the example shown in FIG. 1B is shown in FIG. 1C.

The optical element according to this embodiment is formed by cutting a lens sheet including a plurality of optical elements into predetermined size to thereby singulating the lens sheet. An overview of the lens sheet before singulation of the optical elements is shown in FIG. 1A. As shown in FIG. 1A, the lens sheet according to this embodiment includes a substrate section 1, through-holes 2 provided in the substrate section 1, and lenses 3 formed on the through-holes 2, in the through-holes 2, or in the through-holes 2 and on the through-holes 2. When the lens sheet is singulated to form an optical element, one optical element is formed to include at least one set of the lens 3 and the through-hole 2.

In FIGS. 1B and 1C, concerning the lens sheet shown in FIG. 1A, a sectional view in a thickness direction of a section equivalent to one optical element including one lens 3 is shown. In other words, FIGS. 1B and 1C are the same as a sectional view of the optical element after the singulation. As shown in FIGS. 1B and 1C, the lens sheet includes a substrate 11, a thin film 12, a resin material 13, and the through-hole 2. The lens 3 is formed of a transparent resin material 13. The substrate section 1 shown in FIG. 1A includes the substrate 11, the thin film 12, and the resin material 13 in a section other than the lens 3.

As shown in FIG. 1B, the substrate 11, the thin film 12, and the resin material 13 can be arranged in order of the substrate 11, the thin film 12, and the resin material 13. Alternatively, as shown in FIG. 10, the substrate 11, the thin film 12, and the resin material 13 can be arranged in order of the thin film 12, the substrate 11, and the resin material 13. As shown in FIG. 1B, the through-hole 2 and the lens 3 can be arranged on both the side of the thin film 12 (in FIG. 1B, on and under the thin film 12). As shown in FIG. 1C, the through-hole 2 and the lens 3 can be arranged in the same direction with respect to the thin film 12 and the lens 3 can be arranged in a position including the inside of the through-hole 2.

The arrangement of the through-holes 2 (the arrangement of the lenses 3) provided in the lens sheet is not specifically limited. The as shown in FIG. 1A, the through-holes 2 can be arranged at equal intervals or can be arranged at unequal intervals. The shape of the through-holes 2 is a columnar shape in FIG. 1A. However, the shape of the through-holes 2 is not limited to this and can be any other shapes such as a square pole shape or a taper shape. The shape of the substrate section 1 is not limited to a rectangular shape shown in FIG. 1A and can be any shape such as a circular shape or a polygonal shape. All the through-holes 2 provided in the lens sheet do not have to have the same shape and the same size. The through-holes 2 having different sizes and different shapes can be mixed.

In the lens sheet according to this embodiment, the thin film 12 is arranged on one surface of the substrate 11, in which the through-holes 2 are provided, and in contact with the substrate 11. The thin film 12 is arranged to cover the top or the bottom of the through-hole 2 continuously from a surface the substrate 11 other than the through-hole 2.

To form the lens 3, the resin material 13 is a material having light transmission properties such that optical performance of the lens 3 is satisfied. The resin material 13 is a material suitable for processing in forming the lens 3. For example, when hardening processing (photo-curing processing, heat-curing processing, etc.) is used to form the lens 3, the resin material 13 is a hardening resin material that can be processed by the hardening processing. For example, epoxy resin, acrylic resin, annular polyolefin resin, and silicon resin can be used. In the examples shown in FIGS. 1B and 1C, the resin material 13 covers the entire substrate 11 or thin film 12. However, the resin material 13 does not have to be present in a section unnecessary in forming the lens 3.

As shown in FIG. 1B, the resin material 13 can be formed in contact with the thin film 12 that is in contact with the substrate 11. As shown in FIG. 1C, the resin material 13 can be formed in contact with a surface opposite to the surface of the thin film 12 that is in contact with the substrate 11. In other words, the resin material 13 only has to be formed such that the lens 3 is in contact with the thin film 12 in the position of the through-hole 2 on the substrate 11 and a direction orthogonal to the surface of the substrate 11 is set as a thickness direction of the lens 3. In the case of FIG. 10, the resin material 13 fills the inside of the through-hole 2. The lens 3 is formed in the through-hole 2 and at the top of the through-hole 2 (a surface on the opposite side of a surface in contact with the thin film 12). In this way, the arrangement of the thin film 12, the substrate 11, and the through-hole 2 can be changed according to thickness required of the lens 3. In the case of FIG. 1C, the thickness of the lens 3 can be adjusted by further adjusting the thickness of the substrate 11.

As shown in FIGS. 1B and 1C, the lens 3 is formed in contact with the thin film 12 in the position of the through-hole 2. In FIGS. 1B and 1C, the lens 3 is a convex lens. However, the shape of the lens 3 is not limited to this and can be any shape. The lens 3 can be a convex lens or a concave lens and can be a spherical lens or an aspherical lens. For example, in the case of the concave lens, as in FIG. 1C, the resin material 13 only has to fill the inside of the through-hole 2. The lens 3 only has to be formed to form the top (the surface on the opposite side of the surface in contact with the thin film 12) in a concave shape instead of a convex shape. A method of forming a lens is not specifically limited. However, for example, hardening processing can be used.

A material of the thin film 12 can be any material as long as the material is a transparent material. For example, hardening resin, a silicon oxide film, and a metal oxide can be used. A method of forming the thin film 12 is not specifically limited. For example, the thin film 12 can be formed by photo-curing or can be formed by a chemical vapor deposition (CVD) method. The thin film 12 can be a single layer film or a multilayer film.

A material of the substrate 11 is not limited. However, the material of the substrate 11 is desirably a heat resistant material such that heat treatment can be applied to the material, for example, when the optical element according to this embodiment is mounted on another substrate. In this embodiment, because the lens 3 is formed in the position of the through-hole 2 as explained above, not only the transparent material but also a non-transparent material can be used as the material of the substrate 11. For example, as the material of the substrate 11, silicon, plastic, metal, glass, ceramics, fiber, and a composite material of these materials can be used. If a material to be a light shielding film is used as the material of the substrate 11, the substrate 11 functions as a light shielding film for the lens 3. When the transparent material is used as the material of the substrate 11, a light shielding film does not have to be formed on the substrate 11.

The optical element according to this embodiment is formed by cutting the lens sheet explained above into the predetermined size including at least one set of the lens 3 and the through-hole 2 and singulating the lens sheet.

The sizes of the through-hole 2 and the lens 3, the thicknesses of the thin film 12 and the substrate 11, and the like are not specifically limited. For example, when the lens 3 is formed at a diameter of about 0.6 millimeter and height of about 80 micrometers (height of 0.1 millimeter to 0.2 millimeter from the surface in contact with the substrate 11), an optical element in which the thickness of the substrate 11 is 0.3 millimeter to 0.5 millimeter and the thickness of the thin film 12 is 50 micrometer to 70 micrometer can be formed. These numerical values are only examples. Appropriate numerical values change according to a refractive index or transmittance of a material, a positional relation between the thin film 12 and the lens 3, and the like. Therefore, any values can be used according to conditions.

An optical filter such as an infrared cut filter can be stuck to the thin film 12. The thin film 12 can be imparted with a function of an optical filter by using, for example, a material for cutting an infrared ray in the thin film 12 instead of sticking the optical filter.

Any methods can be used as methods for formation of the through-hole 2 of the substrate 11, formation of the thin film 12, and formation of the lens 3 in this embodiment. Order of these kinds of formation can be any order.

The optical element according to this embodiment can be used as, for example, a lens module of a camera module of a cellular phone or the like. The optical element can also be used as a lens of an apparatus including an optical sensor such as a facsimile or a copying machine.

As explained above, in this embodiment, the lens 3 is formed in the position of the through-hole 2 and the lens 3 is formed in contact with the thin film 12 that is in contact with the surface of the substrate 11. Therefore, because the through-hole 2 is present in the section of the lens 3, attenuation of light due to the substrate 11 does not occur and a non-transparent material can be used as the material of the substrate 11. Because the through-hole 2 is present in the section of the lens 3, even when a thick glass material is used as the substrate 11 to maintain strength, it is possible to realize improvement of optical performance.

In this embodiment, because the lens 3 is formed on the thin film 12, the shape on the substrate 11 side of the lens 3 is a plane. Therefore, it is possible to accurately form the lens 3 in a free shape by a method of, for example, pressing a die against the resin material 13 from the opposite side (the opposite side of the substrate 11 side). For example, the lens 3 having a desired shape can be formed by using photo-curing resin as the resin material 13 and pressing an optically-designed die against the resin material 13 from the side not in contact with the thin film 12, and irradiating light on the resin material 13. In the case of the method in the past of injecting a resin material into through-holes without using the thin film 12 to form a lens, it is necessary to make use of surface tension or press dies to the resin material from both the sides to form a lens. However, in this embodiment, because the die is simply pressed from one side, it is possible to accurately form a desired shape. It is possible to change the thickness of the lens 3 by changing a forming position of the thin film 12 without changing the thickness of the entire optical element. Further, the substrate 11 functions as a light shielding film for the lens 3 depending on the material of the substrate 11 and removes unnecessary light. This makes it possible to further improve the optical performance.

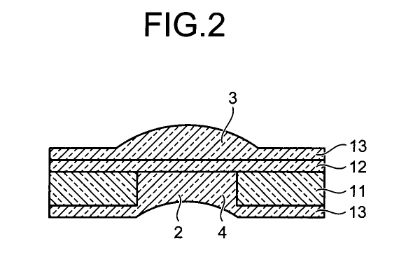

FIG. 2 is a diagram of an example of the structure of an optical element according to a second embodiment of the present invention. Components same as those in the first embodiment are denoted by reference numerals same as those in the first embodiment and explanation of the components is omitted. Differences from the first embodiment are explained below.

As in the first embodiment, the optical element according to this embodiment is singulated after a lens sheet is formed. A sectional view of the singulated optical element is shown in FIG. 2. In the example shown in FIG. 2, the resin material 13 is added under the substrate 11 (in the opposite direction of the surface of the substrate in contact with the thin film 12) in the structure shown in FIG. 1B. The resin material 13 under the substrate 11 forms a lens 4 in the position of the through-hole 2. In this way, in this embodiment, the lens 3 and the lens 4 are respectively formed on both the sides of the thin film 12 in the position of the through-hole 2. In this way, the lenses are formed on both the surfaces of the substrate. This makes it possible to obtain a high degree of freedom in optical design of the lenses.

The resin materials 13 on both the sides of the thin film 12 can be the same resin material or can be resin materials different from each other. When the different resin materials are used, if the thin film 12 is not present, it is likely that two kinds of resin materials are mixed. However, in this embodiment, because the thin film 12 separates the two kinds of resin materials, mixing of the resin materials can be prevented.

When a concave lens like the lens 4 shown in FIG. 2 is formed, in the method in the past of forming a lens on the substrate 11 without providing the through-hole 2, in general, a resin material having thickness same as that of a thickest section (a section at an outer edge) of the concave lens is formed on the substrate 11 and in a shape for shaving a hollow section of a convex lens. On the other hand, in this embodiment, the lens 4 is formed using the inside of the through-hole 2. Therefore, the thickness of the resin material can be reduced compared with the method in the past.

In the example shown in FIG. 2, two lenses are formed using the front surface and the rear surface of one thin film 12. However, a method of forming two lenses is not limited to this. It is also possible to form thin films 12 on both the front surface and the rear surface of the substrate 11 to cover the through-hole 2 and form lenses on sides of the respective thin films 12 not in contact with the substrate 11 to thereby form two lenses. For example, in the structure shown in FIG. 2, it is also possible to further form the thin film 12 on the side of the substrate 11 not in contact with the thin film 12 and form a lens on a side of the formed thin film 12 not in contact with the substrate 11.

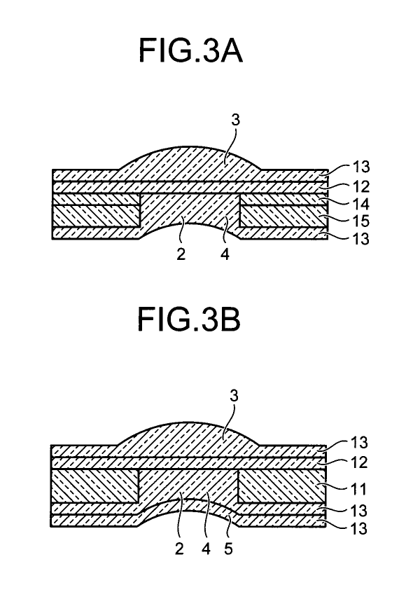

FIGS. 3A and 3B are diagrams of examples of other kinds of the structure of the optical element according to this embodiment. As shown in FIG. 3A, the optical element according to this embodiment can include, instead of the substrate 11, a laminated substrate obtained by laminating a substrate 14 and a substrate 15. The laminated substrate is not limited to two layers and can be formed in any number of layers. The laminated substrate can be used when the lens 3 is formed on one side as explained in the first embodiment.

As shown in FIG. 3B, a lens 5 can be formed by the resin material 13 in contact with a surface of the lens 4 in the opposite direction of the substrate 11. The resin material 13 forming the lens 5 and the resin material 13 forming the lens 4 can be the same resin material or can be different resin materials. In this way, the optical element can have structure in which lenses are laminated. Lenses can be laminated on both the sides of the thin film 12, for example, a lens is further formed on the lens 3 shown in FIG. 3B. The lamination of lenses is not limited to two layers and can be any number of layers. When the lens 3 is formed on one side as explained in the first embodiment, a lens can be laminated in the opposite direction of the thin film 12 (e.g., in FIG. 3B, on the lens 3). A lens can be further laminated using the laminated substrate. The structure of the optical element according to this embodiment, a material forming the optical element, and the like other than those explained above are the same as those in the first embodiment.

As explained above, in this embodiment, the lens 3 and the lens 4 are respectively formed on both the surfaces of the thin film 12. Therefore, effects same as those in the first embodiment can be obtained. It is possible to further improve a degree of freedom of optical design.

It is possible to improve a degree of freedom of design of strength, a type of a substrate in use, and the like by using the laminated substrate instead of the substrate 11. The lens 5 can be further laminated on a side of the lens 4 not in contact with the thin film 12. This makes it possible to further improve the degree of freedom of optical design.

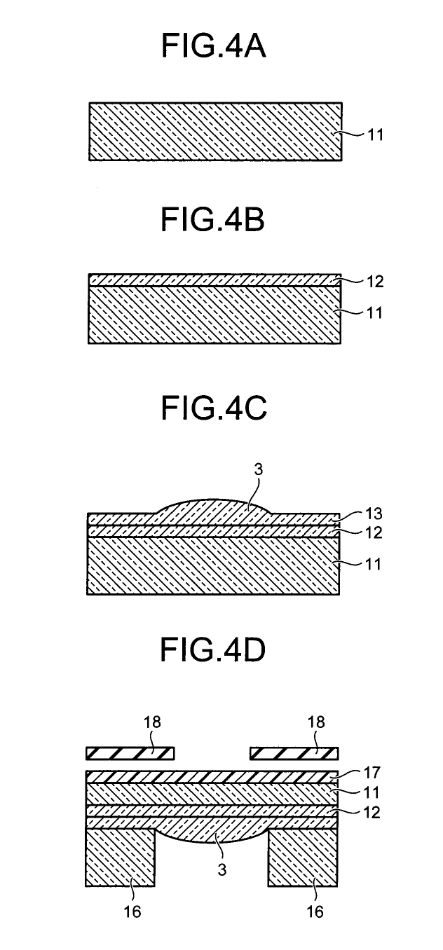

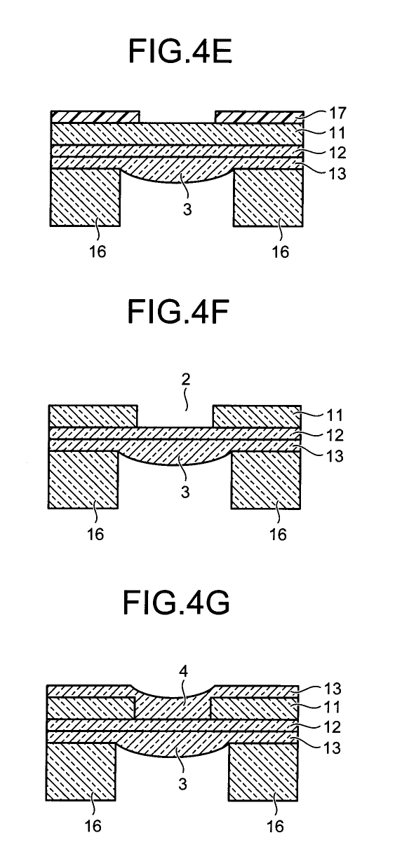

FIGS. 4A to 4G are diagrams of an example of steps of a method of manufacturing an optical element according to a third embodiment of the present invention. Components same as those in the first embodiment are denoted by the same reference numerals and explanation of the components is omitted. Differences from the first embodiment are explained below.

In this embodiment, an example of a method of manufacturing an optical element explained in the first embodiment and the second embodiment is explained. In the example explained in this embodiment, the material of the substrate 11 is silicon and the thin film 12 is a silicon oxide film. A combination of the silicon substrate and the silicon oxide film is used to make it possible to easily apply a general semiconductor manufacturing technology. However, as the thin film 12, another thin film or the like including a silicon compound can be used instead of the silicon oxide.

In the example shown in FIGS. 4A to 4G, an optical element same as the optical element shown in FIG. 2 in the second embodiment is manufactured. First, as shown in FIG. 4A, an unprocessed substrate 11 is prepared. As shown in FIG. 4B, the thin film 12 is formed to cover the surface on one side of the substrate 11 is formed. Processing for forming a silicon oxide film on a silicon substrate is processing usually used for semiconductor chip manufacturing. An oxide film having uniform thickness can be manufactured if a thermal oxidation apparatus or the like is used. The thin film 12 can be formed by the CVD method or the like. An optical filter such as an infrared cut filter is stuck to the thin film 12 at this point according to necessity. As explained in the first embodiment, if a material having a function of the infrared cut filter or the like is used for the thin film 12, the thin film 12 also has a function of the optical filter without the optical filter being stuck to the thin film 12.

Subsequently, as shown in FIG. 4C, the lens 3 is formed on the thin film 12 (the surface of the thin film 12 not in contact with the substrate 11). It is assumed that the lens 3 is formed using an optical imprint method. Specifically, first, the resin material 13 as photosensitive resin is applied on the thin film 12, a die having an optically-designed shape is pressed against the resin material 13, and light is irradiated on the resin material 13. The die is formed of a material that transmits light irradiated by the optical imprint method. The resin material 13 does not need to be applied to cover the entire surface of the substrate 11. A method of dropping the resin material 13 on forming regions of lens set in advance can be adopted.

As shown in FIG. 4D, after a spacer 16 is stuck to surround the circumference of the lens 3, the rear surface (a surface on a side on which the thin film 12 is not formed) of the substrate 11 is ground and a photosensitive resin film 17 is formed after the rear surface is ground. The spacer 16 is used for protecting the formed lens 3 and reducing the influence of deterioration in strength after the grinding of the rear surface of the substrate 11. The thickness of the spacer 16 is not specifically limited. However, the thickness is suitable for attaining the purposes of using the spacer 16. For example, for the protection of the lens 3, thickness larger than the height of the lens 3 is necessary to at least prevent the lens 3 from directly coming into contact with the outside. It is not essential to stick the spacer 16. The spacer 16 is stuck only when necessary in terms of structure or optical design. A material of the spacer 16 is not specifically limited. Any material such as glass or metal can be used (in the example shown in FIGS. 4A to 4G, glass is used).

The thickness of the substrate 11 is reduced by performing the rear surface grinding to make it easy to shave the substrate 11 when the through-hole 2 is provided in the substrate 11 in a later step. However, the rear surface grinding of the substrate 11 is not essential and does not have to be performed. The photosensitive resin film 17 is formed to mask a section not shaved in the later step of shaving the through-hole 2. The photosensitive resin film 17 is exposed via a mask 18 having a light shielding property, whereby the photosensitive resin film 17 is removed leaving a section under the mask 18 and is formed in a shape shown in FIG. 4E.

Etching is performed using the section of the photosensitive resin film 17 remaining on the substrate 11 in FIG. 4E as a mask and the through-hole 2 is formed by shaving the substrate 11 leaving the thin film 12 to obtain a state shown in FIG. 4F. In this case, for example, if cutting by reactive ion etching (RIE) is performed, high selectivity and accuracy can be achieved. The procedure shown in FIGS. 4D to 4F is only an example. A procedure for forming the through-hole 2 and obtaining the state shown in FIG. 4F is not limited to the procedure. Any procedure can be used as long as the through-hole 2 is formed in a predetermined position and the state shown in FIG. 4F is obtained. As a method of forming the through-hole 2, besides the RIE, for example, a machining method, a photolithography method, and a physical processing method by a laser can be used.

The formation of the lens 3 on one surface is finished as explained above. To form lenses on both the sides of the thin film 12, as shown in FIG. 4G, the resin material 13 is poured into the through-hole 2 from the side of the substrate 11 not in contact with the thin film 12, a die is pressed against the resin material 13, and the lens 4 is formed by the optical imprint method. Light irradiation can be performed from the top of FIG. 4G (a side on which the lens 4 is formed) through a transparent die or can be performed from the lens 3 side.

In this embodiment, the thin film 12 separating the lens 3 and the lens 4 is the silicon oxide film and has high stability against organic matters and the like. Therefore, even when the lens 3 and the lens 4 are formed of resin materials different from each other, mixing of the two resin materials can be effectively prevented. Therefore, it is easy to manufacture a lens having less aberration using two kinds of resin materials.

When a laminated substrate is used, substrates can be laminated before the formation of the thin film 12 shown in FIG. 4B or substrates can be laminated after the formation of the lens 3 shown in FIG. 4C. As shown in FIG. 3B, when lenses are laminated, after FIG. 4G, it is sufficient to further apply the resin material 13 on a side on which the lenses are laminated, press a die against the resin material 13, and form the lens 5 with the optical imprint method.

A material of the substrate 11 can be a material other than silicon. A material of the thin film 12 can be a material other than the silicon oxide film. By using these materials, a manufacturing procedure established by a semiconductor manufacturing technology can be used. Processing can be performed inexpensively, in a large volume, and precisely.

As explained above, in this embodiment, after the thin film 12 is formed on the substrate 11 and the lens 3 is formed on the thin film 12 by the optical imprint method using the resin material 13, the through-hole 2 is provided in the position of the substrate 11 corresponding to the lens 3 by etching. Therefore, it is possible to manufacture, inexpensively, in a large volume, and precisely, the optical element explained in the first embodiment and the second embodiment using an element technology established by the semiconductor manufacturing technology.

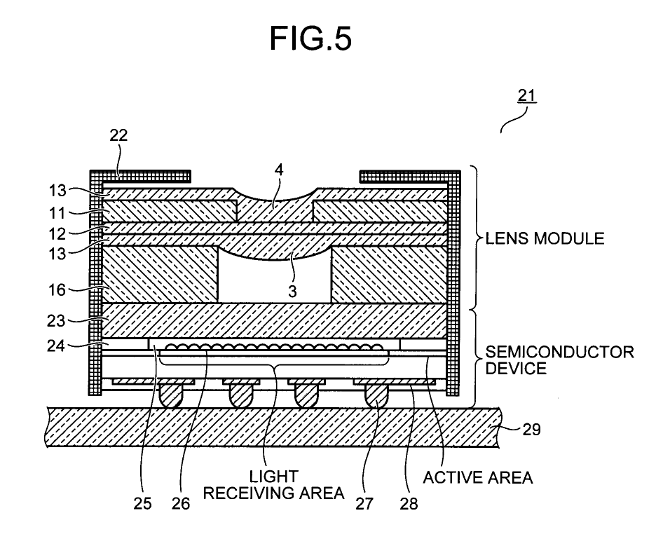

FIG. 5 is a sectional view of an example of the structure of a camera module 21 according to a fourth embodiment of the present invention. The camera module according to this embodiment includes the optical element explained in the first embodiment or the second embodiment.

As shown in FIG. 5, the camera module 21 according to this embodiment includes a semiconductor device, a lens module, and a shield cap 22 that surrounds the semiconductor device and the lens module. The lens module is the optical element explained in the first embodiment or the second embodiment. In the example shown in FIG. 5, the optical element shown in FIG. 4G is used as the lens module.

The semiconductor device receives light condensed via the lens module, generates image data from the light, and outputs the image data to a substrate 29. As shown in FIG. 5, an active area including a light receiving area (an imaging element: e.g., a charge coupled device (CCD) imaging element or a complementary metal oxide semiconductor (CMOS) element) is formed on the surface of the semiconductor device. The light receiving area is covered with protective glass (e.g., quartz glass or borosilicate glass) 23 via an adhesive material (e.g., epoxy resin or polyimide resin). In general, a micro lens 26 for condensing light is present on the light receiving area. A cavity (a space) 25 is provided to prevent light condensing performance of the micro lens 26 from being spoiled. The protective glass 23 for protection and the spacer 16 are bonded via the bonding material (not shown), whereby the lens module is arranged on the protective glass 23.

In the camera module 21, light condensed via the lens 3 and the lens 4 of the lens module is made incident on the light receiving area through the protective glass 23. In the light receiving area, the incident light is converted into an electric signal by photoelectric conversion. A control unit (not shown) such as a control IC present in the light receiving area processes the electric signal into image data and outputs the image data to the substrate 29 through wiring layers 28 and external terminals 27. The substrate 29 is connected to a storage device and a display device not shown in the figure. The image data is stored in the storage device or displayed on the display device.

The shield cap 22 is provided to block light from sides. A shape of the shield cap 22 can be a shape for surrounding the sides and the top (an opening side) of the lens module and the semiconductor device excluding a section above the lens 3 and the lens 4 as shown in FIG. 5 or can be a shape for surrounding only the sides of the lens module and the semiconductor device.

The configuration of the semiconductor device shown in FIG. 5 is only an example. The semiconductor device is not limited to the configuration shown in FIG. 5. Any semiconductor device can be used as long as the semiconductor device includes an imaging element that photoelectrically converts light from the lens module.

It is assumed that, like the lens module (the optical element), the semiconductor device according to this embodiment is manufactured by the manufacturing method for mounting a plurality of semiconductor devices on one substrate (hereinafter referred to as sensor substrate) and, thereafter, singulating the semiconductor devices. In this case, the sensor substrate and a lens sheet can be bonded at a substrate level to form a camera module at the substrate level and, thereafter, cut and singulated. It is possible to perform mass production using the semiconductor manufacturing technology and inexpensively generate a large volume of camera modules.

In the example explained in this embodiment, the optical element shown in FIG. 4G is used as the lens module. However, the lens module is not limited to this. It is also possible to stick the spacer 16 to the optical element explained in the first embodiment or the optical element in which the substrate and the lenses are laminated explained in the second embodiment and use the optical element as the lens module.

In the example shown in FIG. 5, one optical element is used as the lens module. However, two or more optical elements can be superimposed and used as a lens module. In this case, the lower surface of the spacer 16 of the optical element closest to the opening is bonded to overlap the top (the opening side) of the optical element under the spacer 16 (on the semiconductor device side). When three or more optical elements are superimposed, in the same manner, a lens module obtained by combining a large number of lenses can be formed by vertically superimposing the optical elements.

As explained above, in this embodiment, the camera module is configured by the lens module including the optical element explained in the first embodiment and the second embodiment and the semiconductor device that converts light condensed by the lens module into an electric signal and processes the electric signal into image data. Therefore, a non-transparent material can be used as a substrate material of the lens module of the camera module. It is possible to improve a degree of freedom of optical design while maintaining the strength of the lens module. Further, when the camera module is manufactured at a substrate level, the substrate and a lens sheet are bonded and then singulated. This makes it possible to inexpensively generate a large volume of camera modules.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical element comprising:
a substrate in which a through-hole is formed;
a transparent thin film formed on at least one of a rear surface and a front surface of the substrate to cover the through-hole; and
a lens formed in contact with a surface of the thin film in an area where the thin film covers the through-hole.

2. The optical element according to claim 1, wherein the lens is formed of a hardening resin material.

3. The optical element according to claim 2, wherein the lens is formed of a photo-curing resin material.

4. The optical element according to claim 1, wherein the substrate is a transparent substrate.

5. The optical element according to claim 4, wherein the substrate is formed of one or more materials among a glass material, a plastic material, a ceramic material, and fiber.

6. The optical element according to claim 4, wherein a light shielding film is formed on the substrate.

7. The optical element according to claim 1, wherein the substrate is a non-transparent substrate.

8. The optical element according to claim 7, wherein the substrate is formed of one or more materials among silicon, a plastic material, a metal material, a glass material, a ceramic material, and fiber.

9. The optical element according to claim 7, wherein the substrate is formed of a material functioning as a light shielding film.

10. The optical element according to claim 8, wherein
the substrate is formed of a silicon material, and
the thin film is formed of a material including a silicon compound.

11. The optical element according to claim 1, wherein the thin film is formed of a material that shields an infrared ray.

12. The optical element according to claim 1, further comprising a spacer set to surround the lens on an outer side of an outer circumference of the lens.

13. The optical element according to claim 1, wherein the lens is an aspherical lens.

14. The optical element according to claim 1, wherein the through-hole is a through-hole formed by one or more of RIE, a machining method, a photolithography method, and a physical processing method by a laser.

15. A camera module comprising:
a semiconductor device including an imaging element; and
a lens module that makes light from an outside incident on the imaging element, wherein
the lens module includes:
a substrate in which a through-hole is formed;
a transparent thin film formed on at least one of a rear surface and a front surface of the substrate to cover the through-hole; and
a lens formed in contact with a surface of the thin film in an area where the thin film covers the through-hole.

16. The camera module according to claim 15, wherein the lens is formed of a hardening resin material.

17. The camera module according to claim 15, wherein the substrate is a non-transparent substrate.

18. An optical element manufacturing method comprising:
forming a transparent thin film formed on at least one of a rear surface and a front surface of a substrate;
providing, leaving the thin film, a plurality of through-holes from a side of a surface of the substrate on which the thin film is not formed;
forming a lens in contact with a surface of the thin film in an area where the thin film covers the through hole; and
cutting the substrate on which the thin film and the lens are formed into predetermined size including the thin film and the lens.

19. The optical element manufacturing method according to claim 18, further comprising forming the through-hole with one or more of RIE, a machining method, a photolithography method, and a physical processing method by a laser.

20. The optical element manufacturing method according to claim 18, wherein the substrate is a non-transparent substrate.
